(19) United States
(12) Patent Application Publication
(10) Pub. No.: US 2002/0031716 A1
(43) Pub. Date: Mar. 14, 2002

(54) Light and heat sensitive recording material

(75) Inventors: Kozo Nagata, Shizuoka-ken (JP); Shintaro Washizu, Shizuoka-ken (JP)

Correspondence Address: SUGHRUE, MION, ZINN, MACPEAK & SEAS, PLLC, 2100 Pennsylvania Avenue, N.W. Suite 800, Washington, DC, 20037-3213, US

(73) Assignee: FUJI PHOTO FILM CO., LTD.

(21) Appl. No.: 09/906,114

(22) Filed: Jul. 17, 2001

(30) Foreign Application Priority Data
Jul. 21, 2000 (JP) 2000-221110

(51) Int. Cl. G03C 1/72

(52) U.S. Cl. 430/138

(57) ABSTRACT

A light and heat sensitive material comprising, on a support, a light and heat sensitive recording layer containing a color-developing component A encapsulated in a thermally responsive microcapsule and a photopolymerizable composition containing a substantially colorless compound B having at least a polymerizable group and a portion which reacts with the color-developing component A to develop a color in the same molecule and a photoinitiator outside of the thermally responsive microcapsule, and non-color-developing layers containing a swellable inorganic layer compound.

### BACKGROUND OF THE INVENTION

1. Field of the Invention

The present invention relates to a recording material, and, particularly, to a light and heat sensitive recording material favorable for improving recording sensitivity at a time of exposure and thus attaining high speed image recording.

2. Description of the Related Art

Various studies have been made concerning dry type image recording methods which use no liquid developing agent and produce no waste. Among these methods, a method using a composition which is hardened by light has been attracting attention.

This method is characterized by the fact that the composition which is contained in the recording material and hardened by light is polymerized and hardened by exposure to form a latent image whereas a component which is contained in the unexposed portion in the recording material and acts on a color developing reaction by heating is transferred in the recording material to form a color image. When using a recording material for use in such a system, first the recording material is exposed through an image original to harden the exposed portion and thereby form a latent image and then heated to transfer the component which is contained in the unhardened portion (unexposed portion) and acts on a color developing reaction thereby forming a visible image.

This system ensures that a perfect dry system in which no waste is generated can be attained.

The applicant of the present invention previously proposed a recording material as the recording material used in the above system as described in the publication of JP-A-3-87827. This recording material is a light and heat sensitive recording material provided with a light and heat sensitive recording layer comprising an electron-donating colorless dye encapsulated in a microcapsule, and outside the microcapsule are provided, a composition which hardens on exposure to light consisting of a compound containing an electron-receiving group and a polymerizable group in the same molecule and a photoinitiator.

In the light and heat sensitive recording layer, the composition which hardens on exposure to light and is contained outside of the microcapsule is polymerized and hardened by exposure to form a latent image. Thereafter, the electron-receiving compound existing in the unexposed portion is transferred in the recording material and reacts with the electron-donating colorless dye by heating to develop a color. Therefore, the latent image portion hardened in the exposed portion does not develop a color and only the unhardened portion develops a color whereby a high contrast and vivid positive image can be formed.

The process of the formation of an image using the above light and heat sensitive material involves an exposure step of polymerizing and hardening the composition which hardens on exposure to light by image exposure to form a latent image, a color-developing step of developing the color of the color developing component encapsulated in the microcapsule in accordance with the latent image by heating and a fixing step of irradiating the recording layer with light to fix the formed image and to remove the color of the photoinitiator component. In recent years, there has been a need for higher speed image formation and, particularly, there has been a desire to improve recording sensitivity at a time of exposure in the exposure step of forming a latent image.

### SUMMARY OF THE INVENTION

It is an object of the present invention to provide a light and heat sensitive recording material which has high recording sensitivity at a time of exposure in an exposure process in which a latent image is formed by image exposure of a photopolymerizable composition and which can form a high quality image at high speed.

The above-mentioned object can be attained by the following means.

An aspect of the present invention is a light and heat sensitive material comprising, on a support, a light and heat sensitive recording layer comprising a color-developing component A encapsulated in a thermally responsive microcapsule and a photopolymerizable composition including a substantially colorless compound B having at least a polymerizable group and a portion which reacts with the color-developing component A to develop a color in the same molecule and a photoinitiator outside of the thermally responsive microcapsule, and at least one non-color-developing layer containing a swellable inorganic layer compound.

### DESCRIPTION OF THE PREFERRED EMBODIMENTS

A light and heat sensitive recording material according to the present invention will be hereinafter described in detail.

The light and heat sensitive recording material of the present invention comprises, on a support, a light and heat sensitive recording layer comprising a color-developing component A encapsulated in a thermally responsive microcapsule and a photopolymerizable composition including a substantially colorless compound B having at least a polymerizable group and a portion which reacts with the color-developing component A to develop a color in the same molecule and a photoinitiator outside of the thermally responsive microcapsule, and at least one non-color-developing layer containing a swellable inorganic layer compound.

In the above light and heat sensitive recording material, alight and heat sensitive recording layer may be formed by being applied either as a single layer or as a laminate layer of two or more layers. Also, the non-color-developing layer may be formed by being applied as an undercoat layer, intermediate layer or protective layer of the above light and heat sensitive recording layer. Further, the non-color-developing layer may be formed by being applied as a back coat layer on the side of the support opposite to the light and heat sensitive recording layer.

Among the above structures, the structure in which at least one of the above non-color-developing layers is formed as an undercoat layer between the support and the light and heat sensitive recording layer is preferable.

(Non-Color-Developing Layer)

First, the aforementioned non-color-developing layer will be described.

The non-color-developing layer contains a swellable inorganic layer compound and a binder component and is a layer having substantially non-color-developing ability.

The position where the non-color-developing layer is formed by applied can be suitably chosen as long as characteristics and operations of the light and heat sensitive recording material of the present invention are not hindered. Accordingly, the non-color-developing layer may be formed by applying on the support as, for example, an undercoat layer or intermediate layer of the light and heat sensitive recording layer, a layer placed between the uppermost layer of the light and heat sensitive recording layer and protective layer, a protective layer or a back coat layer.

The non-color-developing layer contains a binder component. Preferable examples of the binder component include a gelatin, polyvinyl alcohol and modified polyvinyl alcohol. The thickness of the non-color-developing layer is preferably 0.5 μm to 5.0 μm, more preferably 0.5 μm to 3.0 μm and particularly preferably 0.5 μm to 2.0 μm. The value of the dry weight (g/m²) of the non-color-developing layer after it is applied becomes almost equal to the value of the thickness (μm) of the non-color-developing layer.

<Swellable Inorganic Layer Compound>

Examples of the swellable inorganic layer compound include bentonite, hectorite, saponite, teniorite, tetrasick mica, beidelite, nontronite, stevensite, montmorillonite, talc, zirconium phosphate, swellable clay minerals such as mica groups, swellable synthetic mica and swellable synthetic smectites.

These swellable inorganic layer compounds have a laminate structure consisting of unit crystal lattice layers having a thickness of 10 to 15 angstroms and have larger metal substitution in the lattice than that of other clay mineral. As a result, the lattice layer lacks a positive charge and adsorbs a cation such as Na⁺, Ca²⁺ or Mg²⁺ between layers to compensate the lack of a positive charge. These cations interposed between layers are called exchangeable cations and are exchanged with various cations. Particularly in the case where the interlayer cation is Li⁺ or Na⁺, because the ion radius is small, bonding strength between laminate crystal lattices is weak and the compound is swelled to a great extent by water. When a shear is applied in this state, the crystal lattices easily cleave so that the compound forms a stable sol in water. It is to be noted that this sol has high transparency in general.

Among the aforementioned examples, bentonite and swellable synthetic mica are preferable, swellable synthetic mica is more preferable and fluorine type swellable synthetic mica is particularly preferable in the present invention.

Given as preferable examples of the swellable synthetic mica are Na tetrasic mica: NaMg_{2.5}(Si₄O₁₀)F₂, Na or Li teniorite: (NaLi)Mg₂Li(Si₄O₁₀)F₂ and Na or Li hectorite: (NaLi)_{1/3}Mg_{2/3}Li_{1/3}(Si₄O₁₀)F₂.

The thickness of the swellable inorganic layer compound is 0.1 μm at the most (0.1 μm or less), preferably 0.05 μm at the most (0.05 μm or less) and more preferably 1 to 50 nm. Also, as the face size is preferably 1 to 20 μm. It is more desirable that the aforementioned thickness be lower in view of controlling the diffusibility of the swellable inorganic layer compound and it is more preferable that the face size be larger as long as it does not impair the smoothness and transparency of the coating surface.

Therefore, it is preferable that the aspect ratio of swellable inorganic layer compound be made larger to the extent that the coating ability of a coating solution containing the swellable inorganic layer compound is not impaired. The aspect ratio is 20 or more at least, preferably 100 or more, more preferably 200 or more and particularly preferably 500 or more. The aspect ratio is a ratio of the thickness to length of a particle.

Also, as to the size of the swellable inorganic layer compound, the average length is 0.3 to 20 μm, preferably 0.5 to 10 μm and more preferably 1 to 5 μm.

<Binder Component>

As preferable examples of the binder component contained in the non-color-developing layer, a water-soluble polymer is given.

Examples of the water-soluble polymer include gelatins, gelatin derivatives, graft polymers of gelatins and other polymers, polyvinyl alcohol types, polyamide types and polymers having an amide group and a carboxyl group.

Among these polymers, gelatins, polyvinyl alcohol and modified polyvinyl alcohol are preferable.

Among these modified polyvinyl alcohols, carboxy modified polyvinyl alcohol, silanol modified polyvinyl alcohol and epoxy modified polyvinyl alcohol are desirable in view of adhesion to the adjoining layer.

Moreover, as the above gelatin, other than a gelatin treated with lime, a gelatin treated with an acid may be used. A hydrolyzed gelatin and an enzymatically decomposed gelatin may also be used. Given as examples of the above gelatin derivatives are those obtained by reacting each of acid halides, acid anhydrides, isocyanates, bromoacetic acid, alkane sultones, vinylsulfonamides, maleinimide compounds, polyalkylene oxides and epoxy compounds with a gelatin.

In the above non-color-developing layer, the ratio (swellable inorganic layer compound/binder) by mass of the swellable inorganic layer compound to the binder component is preferably 1/100 to 55/100.

If the above mass ratio is under 1/100, there is the case where the effect of the addition of the swellable inorganic layer compound is insufficiently produced whereas if the ratio is above 55/100, cracks may be caused and powder may fall from the layer.

When the non-color-developing layer is formed by application as an undercoat layer or an intermediate layer, even a smaller mass ratio gives rise to a few problems and a mass ratio as small as about 1/100 to 10/100 is preferable. On the other hand, when the non-color-developing layer is formed as a back coat layer, the mass ratio is preferably larger and a mass ratio as large as about 1/100 to 50/100 is preferable.

In the non-color-developing layer containing the swellable inorganic layer compound, the swellable inorganic layer compound works to produce a barrier effect (e.g., the effect of preventing the permeation of oxygen) and a curling preventive effect and electrostatic interaction between the swellable inorganic layer compound and the binder produces effects of, for example, fixing the binder firmly.

In the case where the non-color-developing layer is formed by applying the layer as an undercoat layer of the light and heat sensitive recording layer, the undercoat layer provides a high barrier effect (effect of preventing the permeation of oxygen) and excellent image preservation ability (light resistance) and besides, recording sensitivity at a time of exposure in the light and heat sensitive recording layer in an exposure step is improved, enabling high speed formation of an image. Also, compared with an undercoat layer excluding the swellable inorganic layer compound, an equal or better effect can be obtained even if the thickness is smaller.

Also, when the non-color-developing layer is formed by being applied as an intermediate layer between the light and heat sensitive recording layers, the intermediate layer is superior in keeping qualities and prevents the mixing of the components respectively contained in the light and heat sensitive recording layers respectively disposed on both sides of the intermediate layer. This contributes to improvements in the recording sensitivity of the light and heat sensitive recording material.

When the non-color-developing layer is formed by being applied as a back coat layer of the light and heat sensitive recording material, the back coat layer prevents the curling of the light and heat sensitive recording material.

(Light and Heat Sensitive Recording Layer)

Next, the light and heat sensitive recording layer of the light and heat sensitive recording material of the present invention will be described. The light and heat sensitive recording layer is a layer on which an image is actually formed and is a positive type recording layer. The light and heat sensitive recording layer may be either a monolayer structure or a multilayer structure. The light and heat sensitive recording layer may be either those used for recording a monochromatic image, namely the so-called black-white (B/W) image or those used for recording a full-color image.

The light and heat sensitive recording layer is usually formed on the support or on the aforementioned other layers by applying a coating solution for the light and heat sensitive recording layer, which solution contains each component for the light and heat sensitive recording layer, to the support or the other layers.

A preferable embodiment of the light and heat sensitive recording layer in the light and heat sensitive recording material of the present invention includes a light and heat sensitive recording layer comprising a thermally responsive microcapsule in which a color-developing component A is encapsulated and a photopolymerizable composition containing a substantially colorless compound B having at least a polymerizable group and a portion which reacts with the color-developing component A to develop a color in the same molecule and a photoinitiator outside of the microcapsule.

In the light and heat sensitive recording layer, the photopolymerizable composition contained outside of the microcapsule is allowed to undergo a polymerization reaction by a radical generated from the photoinitiator and hardened by exposure to form an image of a desired shape by forming a latent image of the desired image shape. Then, by heating the recording layer, the compound B existing in the unexposed portion is transferred in the recording material and reacts with the color-developing component A contained in the capsule to develop a color.

Therefore, the light and heat sensitive recording layer is a positive type light and heat sensitive recording layer in which no color is developed in the exposed portion and the non-hardened portion in the unexposed portion develops a color to form an image.

Moreover, specific embodiments of the light and heat sensitive recording layer include an embodiment described in JP-A-3-87827. Specifically, this embodiment uses, as the light and heat sensitive recording layer, a layer comprising a composition which hardens on exposure to light including a compound having an electron-receiving group and a polymerizable group in the same molecule and a photoinitiator outside of a microcapsule and an electron-donating colorless dye encapsulated in the microcapsule.

In the light and heat sensitive recording layer, the composition which hardens on exposure to light contained outside of the microcapsule is polymerized and hardened by exposure to form a latent image. Thereafter, by heating, the electron-receiving compound existing in the unexposed portion is transferred in the recording material and reacts with the electron-donating colorless dye contained in the microcapsule to develop a color. Therefore, the hardened latent image portion in the exposed portion does not develop a color and only the unhardened portion develops a color, enabling the formation of a high contrast and vivid positive image.

The light and heat sensitive recording material of the present invention may be preferably used in a method of recording a color image. Examples of an image recording method using the light and heat sensitive recording material of the present invention includes an image recording method comprising an exposure step of allowing the photopolymerizable composition to form a latent image by image exposure, a color-developing step of allowing the color-developing component to develop a color corresponding to the latent image thereby forming an image and a fixing step of irradiating the surface of the recording layer with light to fix the image and to remove the color of the photoinitiator component.

In the above exposure step, the photopolymerizable composition in the layer is exposed to form an image having a shape corresponding to a pattern of the desired image shape by forming a latent image. Then, in the color-developing step, the surface of the recording layer is heated to react the color-developing component contained in the light and heat sensitive recording layer having the compound which reacts with the color-developing component or with a specific color-developing group contained in the compound to develop a color in the form of the latent image formed in advance thereby forming an image.

As the light source used for the formation of an image in the above exposure step, a light source optionally selected from light sources having light source wavelength in the ultraviolet region to the infrared region may be used by using a light-absorbing material, such as a spectral sensitizing compound, which absorbs light in a specific region, in the light and heat sensitive recording layer. More specifically, a light source having the maximum absorption wavelength in a range between 300 and 1000 nm is preferred.

In this case, it is preferable to select and use a light source having a wavelength matching to the absorption wavelength of the light-absorbing material such as a spectral sensitizing compound to be used. This selective use of the light-absorbing material ensures that light sources of blue to red colors, can be used and that a compact and inexpensive infrared laser and the like also can be used. This not only broadens the applications of the recording material but also makes it possible to attain high sensitization and high vividness.

Among the above light sources, it is preferable to use, particularly, a laser source or LED of blue color, green color, red color or the like to allow the equipment to be simple compact and inexpensive.

The image recording method using the light and heat sensitive recording material of the present invention is provided with a fixing step in succession to the above color-developing step, the fixing step comprising further irradiating the entire surface of the recording layer with light from a specific light source to fix the image formed in the above color-developing step and to remove the coloring due to the photoinitiator remaining the recording layer. Processing in the fixing step makes it possible to raise the whiteness of the non-image portion and therefore a final image which is chemically stable can be obtained. When a diazonium salt compound is used as the color-developing component, the diazonium salt compound left in the recording layer after an image is formed is also deactivated by irradiation with light. The use of diazonium salt compound can contribute to the preservation stability of the formed image so that the image is kept without any change in density and discoloration.

This light and heat sensitive recording material is also used as a transfer type to be used in a method in which after a color image is formed, the image is transferred to a separate non-transfer support. In the case of using the recording material like this, a thermoadhesive layer is formed in advance on the light and heat sensitive recording layer to thereby improve the transferability. Here, when the support is peeled off after the recording material is processed in the above transfer step, the light and heat sensitive recording layer on which the color image is formed is adhered to the image-receiving material through the surface of the thermoadhesive layer formed as desired to form a transfer image on the side of the image-receiving material. After that, the entire surface of the light and heat sensitive recording layer is irradiated with light from a specific light source. The same effect as that in the above fixing step is thereby obtained.

As the light source used in the above fixing step, a wide range of light source such as a mercury lamp, extra-high pressure mercury lamp, electrodeless discharge type mercury lamp, xenon lamp, tungsten lamp, metal halide lamp or fluorescent lamp may be preferably used.

It is preferable that among the above light sources, a light source having a wavelength matching the absorption wavelength of the photoinitiator used in the light and heat sensitive recording layer of the light and heat sensitive material be appropriately selected and used.

There is no particular limitation for a method of light irradiation using the above light source in the fixing step. A method in which the entire surface of the recording layer is irradiated at one time and a method in which the recording surface is irradiated gradually with light by scanning and finally the entire surface is irradiated may be used. Namely, any method may be used as long as the entire recording surface of the light and heat sensitive recording material after the image is formed can be irradiated finally. It is preferable to irradiate the entire recording layer or transferred recording layer with light in this manner.

As to the time required for light irradiation using the above light source, it is necessary to irradiate for the time required to fix the formed image and to remove the color of the background portion sufficiently. It is preferable to irradiate for a time ranging from several seconds to tens of minutes with the view of obtaining sufficient image-fixing ability and color-removing ability and it is more preferable to irradiate for a time ranging from several seconds to several minutes.

Next, the structural components of the light and heat sensitive recording layer in the light and heat sensitive material of the present invention will be explained.

<Color-developing component A>

Examples of the color-developing component A encapsulated in a microcapsule in the light and heat sensitive recording layer include a substantially colorless electron-donating dye or a diazonium salt compound.

As the electron-donating colorless dye, conventionally known dyes may be used and any dye which reacts with the above compound B to develop a color may be used.

Given as specific examples of the color-developing components are compounds described in the publication of JP-A-2000-199952. Examples of the electron-donating compound are described in the paragraphs No. [0051] to No. [0059] and examples of the electron-donating colorless dyes for each of cyan, magenta and yellow color-developing dyes which are used in combination with the above electron-donating compound in the case where the light and heat sensitive recording material of the present invention is used as a full-color recording material are described in the paragraph No. [0060] in the specification of the same publication.

The above electron-donating colorless dye is used in an amount ranging preferably from 0.1 to 1 g/m² and more preferably from 0.1 to 0.5 g/m² in the light and heat sensitive recording layer. If the amount is less than 0.1 g/m², only insufficiently developed color density can be obtained whereas if the amount exceeds 1 g/m², only poor coating ability is obtained and therefore the amount out of the above range is undesirable.

Also, examples of the above diazonium salt compound may include compounds represented by the following formula.

Ar—N₂⁺X⁻

wherein Ar represents an aromatic cyclic group and X⁻) represents an acid anion.

This diazonium salt compound may be a compound which undergoes a coupling reaction with a coupler by heating to develop a color or one which is decomposed by light. The maximum absorption wavelength of each of these compounds can be controlled by the position and type of substituent in an Ar portion.

The maximum absorption wavelength λ max of the diazonium salt compound used in the present invention is preferably 450 nm or less and more preferably 290 to 440 nm. Also, the diazonium salt compound used in the present invention preferably has the characteristics that the number of carbon atoms is 12 or more, the solubility in water is 1% or less and the solubility in ethyl acetate is 5% or more.

Specific examples of the diazonium salt compound which may be preferably used in the image recording method of the present invention include compounds exemplified in the paragraphs No. [0064] to No. [0075] in the publication of JP-A-2000-199952, which however are not intended to limiting of the present invention.

In the present invention, the diazonium salt compounds may be used either independently or in combinations of two or more corresponding to various purposes such as the regulation of colors.

The diazonium salt compound is used in an amount ranging preferably from 0.01 to 3 g/m² and more preferably from 0.02 to 1.0 g/m² in the light and heat sensitive recording layer. When the amount is less than 0.01 g/m², only insufficient color-developing ability can be obtained whereas when the amount exceeds 3 g/m², the sensitivity is reduced and necessity for extending fixing time arises and therefore an amount out of the above range is undesirable.

<Colorless Compound B>

As the substantially colorless compound B which is used in the light and heat sensitive recording layer and has a polymerizable group and a portion which reacts with the above color-developing component A in the same molecule, an electron-receiving compound having a polymerizable group or any compound such as a coupler compound having a polymerizable group and having both abilities to react with the above color-developing component A to develop a color and to react to light to be thereby polymerized and hardened may be used.

As the above electron-receiving compound having a polymerizable group, namely, the compound having an electron-receiving group and a polymerizable group in the same molecule, any compound which has a polymerizable group and reacts with the electron-donating colorless dye used as one of the above color-developing component A to develop a color and is photopolymerized to harden the film may be used.

Examples of the above electron-receiving compound include 3-halo-4-hydroxybenzoic acid as described in JP-A-4-226455, a methacryloxyethylester and acryloxyethylester of benzoic acid having a hydroxy group as described in JP-A-63-173682, esters of benzoic acid having a hydroxy group and hydroxymethylstyrene as described in JP-A-59-83693, JP-A-60-141587 and JP-A-62-99190, hydroxy styrene as described in European Patent No. 29323, N-vinylimidazole complexes of zinc halide as described in JP-A-62-167077 and JP-A-62-16708 and compounds which can be synthesized using as a reference to electron-receiving compounds or the like as described in JP-A-63-317558.

Among these compounds having an electron-receiving group and a polymerizable group in the same molecule, 3-halo-4-hydroxybenzoic acid represented by the following formula are preferable.

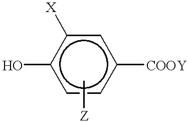

wherein X represents a halogen atom and is preferably a chlorine atom, Y represents a monovalent group having a polymerizable ethylene group and is preferably an alalkyl group having a vinyl group, an acryloyloxyalkyl or a methacryloyloxyalkyl group and more preferably an acryloyloxyalkyl group having 5 to 11 carbon atoms or a methacryloyloxyalkyl group having 6 to 12 carbon atoms and Z represents a hydrogen atom, an alkyl group or an alkoxy group.

As examples of the above electron-receiving compound, 3-halo-4-hydroxybenzoic acid is given and as other specific examples, those exemplified in the paragraphs No. [0082] to No. [0087] in the aforementioned JP-A-2000-199952 are given.

The electron-receiving compound having a polymerizable group is used in combination with the electron-donating colorless dye.

In this case, the electron-receiving compound is used in an amount ranging preferably from 0.5 to 20 parts by mass and more preferably from 3 to 10 parts by mass based on 1 part by mass of the electron-donating colorless dye to be used. If the amount is less than 0.5 parts by mass, sufficient developed color density cannot be obtained whereas if the amount exceeds 20 parts by mass, the sensitivity is decreased and the coating ability is inferior and therefore an amount out of the above range is undesirable.

When such an electron-donating colorless dye and an electron-receiving compound are used as the color-developing components, a method in which the types of electron-donating colorless dye and electron-receiving compound are selected and a method in which the coating amount of the formed recording layer is regulated are given as examples of a method used to obtain a predetermined maximum color density.

As the above coupler compound used in the light and heat sensitive recording layer and having a polymerizable group, any compound may be used as long as it has a polymerizable group and reacts with the diazonium salt compound, which is one of the color-developing component A, to develop a color and is photopolymerized to harden the film.

The above coupler compounds are those which couple with a diazo compound in a basic atmosphere and/or a neutral atmosphere to form a dye and plural types may be formed together corresponding to various purposes such as the regulation of the hue.

Specific examples of the coupler compound include those exemplified in the paragraphs No. [0090] to No. [0096] in the publication of the aforementioned JP-A-2000-199952. These examples however are not intended to be limiting of the present invention.

The coupler compound may be added in an amount ranging from 0.02 to 5 g/m² and is added more preferably in an amount ranging from 0.1 to 4 g/m² in the light and heat sensitive recording layer in view of effects. Adding an amount less than 0.02 g/m² is undesirable because of inferior color-developing ability whereas adding an amount exceeding 5 g/m² is undesirable because coating ability is impaired.

The coupler compound may be used in combination with the aforementioned diazonium salt compound.

In this case, the coupler compound is used in an amount ranging preferably from 0.5 to 20 parts by mass and more preferably from 1 to 10 parts by mass based on 1 part by mass of the diazonium salt compound. When the amount is less than 0.5 part by mass, insufficient color developing ability is obtained whereas when the amount exceeds 20 parts by mass, the coating ability is inferior and therefore an amount out of the above range is undesirable.

When such a diazonium salt compound and a coupler compound are used as the color-developing components, a method in which the types of diazonium salt compound and coupler compound are selected and a method in which the coating amount of the formed recording layer is regulated are given as examples of a method used to obtain a desired maximum color density.

The coupler compound may be solid-dispersed using a sand mill or the like by adding a water-soluble polymer together with other components and used. The coupler compound may be emulsified by adding a proper emulsifying adjuvant and used as an emulsion. No particular limitation is imposed on a method of preparing the solid dispersion or emulsion and conventionally known method may be used. The details of these methods are described in JP-A-59-190886, JP-A-2-141279 and JP-A-7-17145.

In the present invention, organic bases such as tertiary amines, piperidines, piperazines, amidines, formamidines, pyridines, guanidines and morpholines may be used for the purpose of promoting a coupling reaction.

These compounds are described in detail in JP-A-57-123086, JP-A-60-49991, JP-A-60-94381, JP-A-9-71048, JP-A-9-77729 and JP-A-9-77737.

Although there is no particular restriction on the amount of the organic base, the organic base is preferably used in an amount ranging from 1 to 30 mol based on 1 mol of the diazonium salt.

Furthermore, a color-developing adjuvant may be added to promote a color-developing reaction.

Examples of the color-developing adjuvant include phenol derivatives, naphthol derivatives, alkoxy substituted benzenes, alkoxy substituted naphthalenes, hydroxy compounds, carboxylic acid amide compounds and sulfonamide compounds.

It is considered that high developed color density is obtained because these compounds have the abilities to lower the melting point of the coupler compound or basic material and to improve the thermal permeability of a microcapsule wall.

<Photoinitiator>

Next, the photoinitiator contained in the light and heat sensitive recording layer of the light and heat sensitive recording material of the present invention will be described.

This photoinitiator generates a radical by light exposure, initiates a polymerization reaction in the layer and can promote the polymerization reaction. The recording layer film is hardened by this polymerization reaction, whereby a latent image having a desired image shape can be formed.

The photoinitiator preferably has a spectral sensitizing compound having a maximum absorption wavelength at 300 to 1000 nm and a compound which interacts with the spectral sensitizing compound. However, if the compound which interacts with the spectral sensitizing compound has functions both as a dye portion having a maximum absorption wavelength at 300 to 1000 nm and as a borate portion, the above spectral sensitizing compound does not need to be used.

As the spectral sensitizing compound having a maximum absorption wavelength at 300 to 1000 nm, a spectral sensitizing dye having a maximum absorption wavelength in this wavelength range is preferable. A desired dye is selected from spectral sensitizing dyes having a maximum absorption wavelength in the above wavelength range and used with the intention of regulating light-sensitive wavelength such that it is suitable for the light source to be used whereby high sensitivity can be obtained. Also, as the light source to be used for image exposure, a light source of a blue color, green color or red color or an infrared laser can be preferably selected.

Accordingly, in the case of using the light and heat sensitive material of the present invention for recording a color image, monochromatic light and heat sensitive recording layers which respectively develop a yellow color, a magenta color and a cyan color are laminated, spectral sensitizing dyes having each different wavelength are respectively provided in each monochromatic layer developing a different color and light sources for each absorption wavelength are used. Therefore, even if a recording material in which plural layers are laminated is used, each layer (each color) forms a highly sensitive and vivid image. So the multicolor light and heat sensitive material as a whole can attain high sensitization and high vividness. The addition of these spectral sensitizing dyes makes it possible to obtain a desired developed color density using lower energy.

As the spectral sensitizing dyes, known compounds may be used.

Given as specific examples of the spectral sensitizing dye are those described in, for example, the patent publication concerning “COMPOUNDS INTERACTING WITH SPECTRAL SENSITIZING COMPOUND”, “Research Disclosure, Vol. 200, December, 1980 Item 20036” and “SENSITIZER” (p.160-p.163, Kodansha; Katsuki Tokumaru & Shin Ohgawara/Edition, 1987).

Specific examples of the spectral sensitizing dye include 3-ketocumalin compounds described in JP-A-58-15603, thiopyrylium salts described in JP-A-58-40302, naphthothiazolemerocyanine compounds described in JP-B-59-28328 and JP-B-60-53300 and merocyanine compounds described in JP-B-61-9621, JP-B-62-3842, JP-A-59-89303 and JP-A-60-60104.

Also, examples of the spectral sensitizing dye may include dyes described in, for example, “CHEMISTRY OF FUNCTIONAL DYE” (1981, CMC Shuppansha, p.393-p.416) and “COLORANT” (60[4] 212-224 (1987)) and specific examples include cationic methine dyes, cationic carbonium dyes, cationic quinoneimine dyes, cationic indoline dyes and cationic styryl dyes.

The spectral sensitizing dyes include keto dyes such as cumarin (including ketocumarin or sulfonocumarin) dyes, merostyryl dyes, oxonol dyes and hemioxonol dyes; non-keto dyes such as non-ketopolymethine dyes, triarylmethane dyes, xanthene dys, anthracene dyes, rhodamine dyes, acridine dyes, aniline dyes and azo dyes; non-ketopolymethine dyes such as azomethine dyes, cyanine dyes, carbocyanine dyes, dicarbocyanine dyes, tricarbocyanine dyes, hemicyanine dyes and styryl dyes; and quinoneimine dyes such as azine dyes, oxazine dyes, thiazine dyes, quinoline dyes and thiazole dyes.

The proper use of the spectral sensitizing dye ensures that the spectral sensitivity of the photoinitiator used in the light and heat sensitive recording material applied to the image recording method of the present invention can be obtained in the ultraviolet to infrared range.

These various spectral sensitizing dyes may be used either singly or in combinations of two or more.

The spectral sensitizing compound is used in an amount ranging preferably from 0.1 to 5 mass % and more preferably from 0.5 to 2 mass % based on the total mass of the light and heat sensitive recording layer.

As the compound which interacts with the spectral sensitizing compound, one or two or more compounds are selected from compounds capable of initiating a photopolymerization reaction with a photopolymerizable group in the compound B. If, particularly, this compound is allowed to coexist together with the spectral sensitizing compound, the compound is efficiently sensitive to an exposure light source having a wavelength in the spectral absorption wavelength range of the spectral sensitizing compound. Therefore, high sensitization is accomplished and the generation of radicals can be controlled by using desired light source having a wavelength in the ultraviolet to infrared region.

Given as examples of the compound which interacts with the spectral sensitizing compound are organic borate salt compounds or compounds described in the paragraphs No. [0145] to No. [0151] in the publication of JP-A-2000-199952.

Among compounds which interact with the spectral sensitizing compound, organic borate compounds, benzoin ethers, S-triazine derivatives having a trihalogen substituted methyl group, organic peroxides, and azinium salt compounds are preferable and organic borate compounds are more preferable.

During exposure, radicals can be generated locally and efficiently in the exposed portion to attain high sensitization by using the compound which interacts with the spectral sensitizing compound together with the spectral sensitizing compound.

Examples of the aforementioned organic borate compound include organic borate compounds (hereinafter sometimes called “borate compound I”) and spectral sensitizing dye type borate compounds (hereinafter sometimes called “borate compound II”) obtained from cationic dyes as described in JP-A-62-143044, JP-A-9-188685, JP-A-9-188686 and JP-A-9-188710.

Specific examples of the above borate compound I include compounds described in the paragraphs No. [0154] to No. [0163] in the publication of the aforementioned JP-A-2000-199952. However, these compounds are not intended to be limiting of the present invention.

Also, examples of the borate compound used in the light and heat sensitive recording material may include spectral dye type borate compounds (borate compound II) which can be prepared from cationic dyes described in, for example, “CHEMISTRY OF FUNCTIONAL DYE” (1981, CMC Shuppansha, p.393-p.416) and “COLORANT” (60[4] 212-224 (1987)).

This borate compound II is a compound having both a portion which functions as a dye portion and a portion which functions as a borate portion in its structure. Specifically, the borate compound II has such three functions that, during exposure, it efficiently absorbs the energy of a light source by light-absorbing function of the dye portion, promotes a polymerization reaction by the radical-discharge function of the borate portion and removes the color of spectral sensitizing compounds which exist together.

To state in more detail, any cationic dye having a maximum absorption wavelength in a wavelength range of 300 nm or more and preferably 400 to 1100 nm may be preferably used. Among these cationic dyes, cationic methine dyes, polymethine dyes, triarylmethane dyes, indoline dyes, azine dyes, xanthene dyes, cyanine dyes, hemicyanine dyes, rhodamine dyes, azamethine dyes, oxazine dyes and acridine dyes are preferable and cationic cyanine dyes, hemicyanine dyes, rhodamine dyes and azamethine dyes are more preferable.

The borate compound II obtained from the aforementioned organic cationic dye may be obtained using an organic cationic dye and an organic boron compound anion with reference to the method described in European Patent No. 223,587A1. Specific examples of the borate compound II obtained from a cationic dye include compounds described in the paragraphs No. [0168] to No. [0174] in the publication of JP-A-2000-199952. However, these examples are not intended to be limiting of the present invention.

Although the borate compound II is a multifunctional compound as aforementioned, the light and heat sensitive recording material preferably has a structure in which as the photoinitiator, a spectral sensitizing compound and a compound which interacts with the spectral sensitizing compound are suitably combined with each other with the view of obtaining high sensitivity and sufficient color-removing ability.

In this case, the photoinitiator is more preferably a photoinitiator (1) obtained by combining the spectral sensitizing compound with the borate compound I or a photoinitiator (2) obtained by combining the borate compound I with the borate compound II.

At this time, the ratio between the spectral sensitizing dye and organic borate compound which exist in the photoinitiator is very important in obtaining high sensitivity and sufficient color-removing ability by irradiation with light in the fixing step.

In the case of the photoinitiator (1), in addition to the ratio of the spectral sensitizing compound/the borate compound I (=1/1: mol ratio) required for a photopolymerization, the addition of the borate compound I in an amount required to remove the color of the spectral sensitizing compound left in the layer sufficiently is particularly preferable in order to obtain satisfactorily high sensitization and color-removing ability.

Specifically, the spectral sensitizing dye and the borate compound I are used in a ratio ranging preferably from 1/1 to 1/50, more preferably from 1/1.2 to 1/30 and most preferably from 1/1.2 to 1/20. When the ratio is less than 1/1, sufficient polymerization reactivity and color-removing ability are not obtained whereas when the ratio exceeds 1/50, the coating ability becomes inferior and therefore such an amount is undesirable.

Also, in the case of the photoinitiator (2), it is particularly preferable to use the borate compound I and the borate compound II by combining the both such that the borate portion is contained in a ratio equivalent by mol or more to the dye portion to obtain sufficiently high sensitization and color-removing ability.

The borate compound I and the borate compound II are used in a ratio ranging preferably from 1/1 to 50/1, more preferably from 1.2/1 to 30/1 and most preferably from 1.2/1 to 20/1. When the ratio is less than 1/1, sufficient polymerization reactivity and color-removing ability are not obtained whereas when the ratio exceeds 50/1, sufficient sensitivity is not obtained and therefore such an amount is undesirable.

It is preferable to use the spectral sensitizing dye and the organic borate compound such that the total amount of both compounds in the photoinitiator is in a range between preferably 0.1 and 10 mass %, more preferably 0.1 and 5 mass % and most preferably 0.1 and 1 mass %. When the amount is 0.1 mass %, the effect of the present invention cannot be obtained whereas when the amount exceeds 10 mass %, the storage stability is decreased and the coating ability is decreased and therefore an amount out of the above range is undesirable.

Also, an oxygen scavenger or a reducing agent such as a chain transfer agent for active hydrogen donor and other compounds for promoting a polymerization reaction in a chain transfer manner may be added as an adjuvant to the photopolymerizable composition contained in the light and heat sensitive recording layer in the light and heat sensitive recording material of the present invention.

Examples of the oxygen scavenger include phosphines, phosphonates, phosphites, argentous salts or other compounds which are easily oxidized.

Specific examples include N-phenylglycine, trimethylbarbituric acid, N,N-dimethyl-2,6-diisopropylaniline and N,N,N-2,4,6-pentamethylanilic acid. Further, thiols, thioketones, trihalomethyl compounds, lophine dimer compounds, iodonium salts, sulfonium salts, azinium salts, organic peroxides, azides and the like are useful as the polymerization promoter.

<Transfer System Light and Heat Sensitive Recording Material>

The light and heat sensitive recording material of the present invention is not limited to the aforementioned light and heat sensitive recording material and may have various structures according to the object as aforementioned.

When the light and heat sensitive recording material of the present invention is used as a transfer system recording material, it is preferable to dispose a thermoadhesive layer on the outermost layer above the light and heat sensitive recording layer. This thermoadhesive layer (heat-sensitive adhesive layer) contains a heat-sensitive adhesive so that the thermoadhesive layer generates heat and adheres to an image-receiving material when it is irradiated with laser light or heated at the time of the formation of an image.

Typical examples of the heat-sensitive adhesive contained in the heat-sensitive adhesive layer may include heat-meltable compounds and thermoplastic resins. Examples of the heat-meltable compounds may include low molecular weight products of thermoplastic resins such as a polystyrene resin, acrylic resin, styrene-acrylic resin, polyester resin and polyurethane resin and various waxes including vegetable waxes such as carnauba wax, haze wax, candelilla wax, rice wax and auriculy wax, animal waxes such as beeswax, insect wax, shellac and whale wax, petroleum waxes such as paraffin wax, microcrystalline wax, polyethylene wax, Fisher-Tropsch wax, ester wax and wax oxide and mineral waxes such as montan wax, ozokerite and ceresine wax. Examples of the heat-meltable compounds may also include rosin derivatives such as rosin, hydrogenated rosin, polymer rosin, rosin modified glycerol, rosin modified malic acid resins, rosin modified polyester resins, rosin modified phenol resins and ester gum, phenol resins, terpene resins, ketone resins, cyclopentadiene resins, aromatic hydrocarbon resins, aliphatic hydrocarbon resins and alicyclic hydrocarbon resins.

As these heat-meltable compounds, those having a molecular weight of usually 10,000 or less and particularly 5,000 or less and a melting point or softening point ranging from 50 to 150° C. are preferable. These heat-meltable compounds may be used either singly or in combinations of two or more.

Given as examples of the thermoplastic resin are ethylene type copolymers, polyamide resins, polyester resins, polyurethane resins, polyolefin type resins, acrylic resins and cellulose type resins. Among these resins, particularly ethylene type copolymers and the like are preferably used.

Examples of this ethylene type copolymer may include ethylene/vinyl acetate copolymers, ethylene/ethylacrylate resins, ethylene/vinyl acetate/maleic acid anhydride resins, ethylene/acrylic acid resins, ethylene/methacrylic acid resins and ethylene/α-olefin copolymers. Among these copolymers, ethylene/vinyl acetate copolymers, ethylene/vinyl acetate type copolymers and ethylene/ethylacrylate resins or ethylene/ethylacrylate type resins such as ethylene/vinyl acetate copolymers, ethylene/ethylacrylate resins and ethylene/vinyl acetate/maleic acid anhydride resins are preferable. Particularly, ethylene/vinyl acetate copolymers are preferable.

These various ethylenic copolymers are preferably those containing comonomer units other than an ethylene unit in a content of 28 mass % or more and particularly 35 mass % or more. The ethylene/vinyl acetate type copolymer such as ethylene/vinyl acetate copolymers and/or the ethylene/ethylacrylate type resin such as ethylene/ethylacrylate resins which have such a specified composition are used as the aforementioned thermoplastic resin or its major components, whereby more improved adhesive strength to even a transfer-receiving material having low surface smoothness can be attained with the result that significantly high fixing ability of the image portion after an image is formed can be actually obtained.

The thermoplastic resin are preferably those having a melt index (MI value) ranging usually from 2 to 1,500 and preferably from 20 to 500. This is because the adhesive strength of the heat-sensitive adhesive with the transfer-receiving material can be made more satisfactory when a thermoplastic resin having a MI value falling in the above range is used. These thermoplastic resins may be used either singly or in combinations of two or more.

The content of the aforementioned heat-meltable compound in the thermoadhesive layer of the light and heat sensitive recording material according to the present invention is in a range usually from 20 to 80 mass % and preferably from 30 to 70 mass %. In the case where the content is excessively small, image defects may be caused when images such as fine characters are formed. On the other hand, in the case where the content is excessively large, this may cause occasionally defects such as blurred background in a non-image portion. Therefore both cases are undesirable. It is appropriate that the content of the thermoplastic resin in the thermoadhesive layer is in a range usually from 5 to 40 mass % and more preferably from 10 to 30 mass %. In the case where the content of the thermoplastic resin is excessively small, this probably causes image defects when an image is formed on paper having low smoothnes whereas in the case where the content is excessively large, blocking tends to be caused at high temperatures and therefore both cases are undesirable.

Further, other known additional components may be contained appropriately in the thermoadhesive layer of the light and heat sensitive recording material according to the present invention according to need to the extent that the effects of the present invention are not impaired. The film thickness of the thermoadhesive layer is in a range usually from 0.2 to 5.0 μm and preferably from 0.5 to 4.0 μm. Also, it is necessary that at least one thermoadhesive layers is formed. The thermoadhesive layer may be structured of two or more layers which respectively differ in, for example, the type and content of colorant and the compounding ratio between the thermoplastic resin and the heat-meltable compound.

<Protective Layer>

The light and heat sensitive recording material applied to the present invention may be provided with a protective layer according to need separately from the non-color developing layer.

The protective layer may have either a monolayer structure or a laminate structure consisting of two or more layers.

Examples of materials used for the protective layer include water-soluble polymer compounds such as a gelatin, polyvinyl alcohol, carboxy modified polyvinyl alcohol, vinyl acetate/acrylamide copolymer, silicon modified polyvinyl alcohol, starch, modified starch, methyl cellulose, carboxymethyl cellulose, hydroxymethyl cellulose, gelatins, gum arabic, casein, styrene/maleic acid copolymer hydrolysate, styrene/maleic acid copolymer half ester hydrolysate, isobutylene/maleic acid anhydride copolymer hydrolysate, polyacrylamide derivative, polyvinylpyrrolidone, sodium polystyrene sulfonate and sodium alginate and latexes such as a styrene-butadiene rubber latex, acrylonitrile-butadiene rubber latex, methylacrylate-butadiene rubber latex and vinyl acetate emulsion.

The storage stability can be more improved by crosslinking the water-soluble polymer compound used in the protective layer. In this case, as a crosslinking agent used for the above crosslinking, a known crosslinking agent may be used. Specific examples of the crosslinking agent include water-soluble initial condensates such as N-methylol urea, N-methylolmelamine and urea-formalin, dialdehyde compounds such as glyoxal and glutaraldehyde, inorganic type crosslinking agents such as boric acid and borax and polyamidoepichlorohydrin.

Further, known pigments, metallic soaps, waxes, surfactants and the like may be used as the components of the protective layer and known UV absorbers and precursors of UV absorbers may be added to the protective layer.

The amount of the protective layer to be applied is preferably 0.2 to 5 g/m² and more preferably 0.5 to 3 g/m².

<Multicolor Multilayer Light and Heat Sensitive Recording Material>

When the light and heat sensitive recording material of the present invention is used for recording a color image, light and heat sensitive recording layers of each of three colors of yellow, magenta and cyan are laminated on a support and microcapsules containing a color-developing component differing in a developed color hue and a photopolymerizable composition sensitized by light having a different wavelength may be contained in each light and heat sensitive recording layer.

The above photopolymerizable compositions can work as photopolymerizable compositions which are respectively sensitized by light having a different wavelength by using spectral sensitizing compounds which respectively have a different absorption wavelength. In this case, an intermediate layer may be interposed between light and heat sensitive recording layers having each color.

The light and heat sensitive recording layer of the multicolor and multilayer light and heat sensitive recording material may be obtained in the following manner.

A first recording layer (transfer layer) containing a microcapsule having a color-developing component developing a yellow color and a photopolymerizable composition which is sensitive to the center wavelength λ₁ of a light source is formed on a support. On that layer, a second recording layer containing microcapsules having a color-developing component developing a magenta color and a photopolymerizable composition which is sensitive to a center wavelength λ₂ is formed. On that layer, a third recording layer containing microcapsules having a color-developing component developing a cyan color and a photopolymerizable composition which is sensitive to a wavelength λ₃ is formed. Thus, these three layers are laminated to structure the light and heat sensitive recording layer.

Also, the light and heat sensitive recording layer may be provided with a protective layer and intermediate layers disposed between each recording layer according to need. Here, these center wavelengths λ₁, λ₂ and λ₃ of each light source are different from each other.

When the light and heat sensitive material provided with the multicolor and multilayer light and heat sensitive recording layer is used to form an image, image exposure is hardened out using plural light sources which respectively have a different wavelength matching to the absorption wavelength of each light and heat sensitive recording layer in an exposure step. By this operation, the recording layers having an absorption wavelength matching to the wavelength of each light source respectively form a latent image selectively and a multicolor image with high sensitivity and vividness can be therefore formed. Moreover, the coloring of the background portion which is caused by the photoinitiator including the spectral sensitizing compound remaining in the layer can be removed by irradiating the surface of the light and heat sensitive recording layer with light after the latent image is transferred to an image-receiving material. Therefore, a high quality image having a high contrast can be formed.

<Microcapsule Including a Color-Developing Component A>

In the formation of an image using the light and heat sensitive recording material of the present invention, the electron-donating colorless dye or diazonium salt compound (hereinafter called “color-developing component A” where appropriate) to be used is encapsulated in a microcapsule and used. As a microencapsulating method, a conventionally known method may be used.

Examples of this method include a method using the coacervation of a hydrophilic wall-forming material as described in U.S. Pat. Nos. 2,800,457 and 2,800,458, an interfacial polymerization method as described in U.S. Pat. No. 3,287,154, U.K. Patent No. 990443, JP-B-38-19574, JP-B-42-446 and JP-B-42-771, a method using polymer precipitation as described in U.S. Pat. Nos. 3,418,250 and 3,660,304, a method using an isocyanate polyol wall material as described in U.S. Pat. No. 3,796,669, a method using an isocyanate wall material as described in U.S. Pat. No.3,914,511, a method using a urea-formaldehyde type or urea formaldehyde-resorcinol type wall material as described in U.S. Pat. Nos. 4,001,140, 4,087,376 and 4,089,802, a method using a wall-forming material such as a melamine-formaldehyde resin or a hydroxypropyl cellulose as described in U.S. Pat. No. 4,025,455, an in-situ method using polymerization of a monomer as described in JP-B-36-9168 and JP-A-51-9079, an electrolysis dispersion cooling method as described in U.K. Patents No. 952807 and No. 965074 and a spray drying method as described in U.S. Pat. No. 3,111,407 and U.K. Patent No. 930422.

The microencapsulating method is not limited to these exemplified methods. However, in the light and heat sensitive recording material of the present invention, particularly, it is preferable to adopt the above interfacial polymerization method in which an oil phase prepared by dissolving or dispersing a color-developing component in a hydrophobic organic solvent which is to be a core of a capsule is mixed with a water phase in which a water-soluble polymer is dissolved, the both mixed phases are emulsion-dispersed using means such as a homogenizer and thereafter the temperature of the emulsion is raised to thereby cause a polymer-forming reaction at the interfaces of oil droplets in the emulsion thereby forming a microcapsule wall of the polymer material.

Specifically, a capsule having a uniform particle diameter can be formed in a short time, leading to the production of a recording material superior in preservation ability.

Reactants forming the polymer are added to the inside and/or outside of the oil droplet. Specific examples of the polymer material include a polyurethane, polyurea, polyamide, polyester, polycarbonate, urea-formaldehyde resin, melamine resin, polystyrene and styrenemethacrylate copolymer and styrene/acrylate copolymer. Among these compounds, a polyurethane, polyurea, polyamide, polyester and polycarbonate are preferred and a polyurethane and polyurea are particularly preferred. The above polymer materials may be used in combinations of two or more.

Examples of the water-soluble polymer include a gelatin, polyvinylpyrrolidone and polyvinyl alcohol.

For example, in the case of using polyurethane as a material of a capsule wall, polyvalent isocyanate and a second material (e.g., polyol or polyamine) which reacts with isocyanate to form a capsule wall are mixed in an aqueous polymer solution (water phase) or an oily medium (oil phase) to be capsulated. These components are emulsion-dispersed and the temperature of the resulting emulsion is raised to cause a polymer-forming reaction at the interface of an oil droplet thereby forming a microcapsule wall.

As the above polyvalent isocyanate and polyol or polyamine which is a counter material reacting therewith, those described in U.S. Pat. Nos. 3,281,383, 3,773,695 and 3,793,268, JP-B-48-40347, JP-B-49-24159, JP-A-48-80191 and JP-A-48-84086 may be used.

When the microcapsule containing the color-developing components is prepared in the present invention, these color-developing components may exist either in a solution state or in a solid state in the capsule.

As the solvent, one similar to the solvent to be used when the composition which hardens on exposure to light is emulsion-dispersed may be used.

When the electron-donating colorless dye or the diazonium salt compound is encapsulated in a solution state in the capsule, these components may be capsulated in a state in which they are dissolved in a medium. In this case, the solvent is preferably used in an amount ranging from 1 to 500 parts by mass based on 100 parts by mass of the electron-donating colorless dye.

Also, when the electron-donating colorless dye or the diazonium salt compound has poor solubility in the above solvent, a low-boiling point solvent having high solubility may be used together as an auxiliary solvent. Examples of this low-boiling point solvent include ethyl acetate, propyl acetate, isopropyl acetate, butyl acetate and methylene chloride.

On the other hand, an aqueous solution in which a water-soluble polymer is dissolved is used for the water phase to be used and the above oil phase is poured into the water phase, followed by emulsion-dispersing by means of a homogenizer. The water-soluble polymer works as a dispersant which makes the dispersion uniform and easy and stabilizes the emulsion-dispersed aqueous solution. Here, a surfactant may be added to at least one of the oil phase and the water phase to emulsion-disperse it more uniformly and stabilize it. As the surfactant, a well-known emulsifying surfactant may be used. When the surfactant is added, the amount of the surfactant to be added is preferably 0.1% to 5% and particularly preferably 0.5% to 2% based on the mass of the oil phase.

As the surfactant to be contained in the water phase, a surfactant excluding those which act on the protective colloid to cause precipitation or coagulation is suitably selected from anionic and nonionic surfactants and used.

Preferable examples of the surfactant include sodium alkylbenzene sulfonate, sodium alkyl sulfate, sodium dioctyl sulfosuccinate and polyalkylene glycol (e.g., polyoxyethylenenonyl phenyl ether).

As aforementioned, the water-soluble polymer contained as a protective colloid in the water phase with which the oil phase is mixed may be optionally selected from known anionic polymers, nonionic polymers and amphoteric polymers.

As the anionic polymer, either natural and synthetic types may be used. For example, those having a COO⁻ group or a —SO₂⁻ group are exemplified.

Specific examples of the anionic polymer include natural products such as gum arabic, alginic acid and pectin; gelatin derivatives such as carboxymethyl cellulose and gelatin phthalate, semisynthetic products such as starch sulfate, cellulose sulfate and ligninsulfonic acid; and synthetic products such as maleic acid anhydride type (including hydrolysates) copolymers, acrylic acid type (methacrylic acid type) polymers or copolymers, vinylbenzenesulfonic acid type polymers or copolymers and carboxy modified polyvinyl alcohol.

As examples of the nonionic polymer, polyvinyl alcohol, hydroxyethyl cellulose and methyl cellulose are given.

As the amphoteric polymer, gelatins are exemplified. Among these gelatins, a gelatin, gelatin derivative and polyvinyl alcohol are preferable.

The above water-soluble polymer is used as an aqueous solution containing 0.01 to 10 mass % of the polymer.

All components, including the color-developing components, to be contained in the light and heat sensitive recording layer, for example, may be solid-dispersed together with the water-soluble polymer, sensitizing agent, other color-developing adjuvant and the like by means of a sand mill. However, it is preferable that these components be used as an emulsified dispersion produced by dissolving these components in advance in a high-boiling point organic solvent which is sparingly soluble or insoluble in water and thereafter mixing the resulting solution with an aqueous polymer solution (water phase) containing the surfactant and/or the water-soluble polymer as a protective colloid, followed by emulsification using a homogenizer. In this case, a low-boiling point solvent may be used as a dissolution adjuvant.

Moreover, all components including the color-developing components may be emulsion-dispersed separately or may be mixed with each other in advance and then dissolved in a high-boiling point solvent to emulsion-disperse these components. A preferable diameter of the emulsion-dispersed particle is 1 μm or less.

The emulsification can be hardened out easily by treating the oil phase containing the above components and the water-phase containing the protective colloid and the surfactant by using means, such as high speed stirring and ultrasonic dispersion, used for usual emulsification of fine particles, these means including known emulsifying machines such as a homogenizer, Gaulin homogenizer, ultrasonic dispersing machine, dissolver and Keddy mill.

After emulsified, the emulsion is heated to 30 to 70° C. to promote a capsule wall-forming reaction. During reaction, it is necessary to add water to decrease the probability of collision among capsules thereby preventing coagulation among capsules and it is also necessary to agitate sufficiently.

Also, a dispersion for preventing coagulation may be newly added during reaction. With the progress of a polymerization reaction, the generation of carbon oxide gas is observed and the end of the generation of gas is regarded as the termination of the capsule wall-forming reaction. Usually, a microcapsule including the object dye can be obtained by carry out the reaction for several hours.

The average particle diameter of the microcapsule used for the light and heat sensitive recording material preferably used in the image recording method of the present invention is preferably 20 μm or less and more preferably 5 μm or less with the view of obtaining high resolution. If the formed microcapsule is excessively small, the surface area for a fixed solid content unhardened and therefore a large amount of the wall agents is required. It is therefore preferable that the average particle diameter be 0.1 μm or more.

<Additives and the Like>

When the light and heat sensitive recording material of the present invention is used for color image recording, the light and heat sensitive recording layers respectively corresponding to each of the three color hues of the light and heat sensitive recording material are structured by laminating each monochromatic light and heat sensitive recording layer on the support. In each light and heat sensitive recording layer, a microcapsule containing the electron-donating colorless dye which develops a different color hue and the composition which hardens on exposure to light containing the spectral sensitizing dye having a different maximum absorption wavelength are contained. When each light and heat sensitive recording layer is irradiated with light, it is sensitized by a light source having each different wavelength to form a multicolor image.

Also, an intermediate layer may be formed between each monochromatic light and heat sensitive recording layer constituting the light and heat sensitive recording layer separately from the non-color developing layer. The intermediate layer is constituted mainly of a binder and may contain additives such as a hardener and polymer latex according to need.

In the light and heat sensitive recording material of the present invention, as the binder to be used for each of the protective layer, light and heat sensitive recording layer and the intermediate layer, the same binders as those used for emulsion dispersion of the aforementioned photopolymerizable composition and water-soluble polymers used when encapsulating the color-developing components may be used. Other than the above binder materials, solvent-soluble polymers including polystyrene, polyvinylformal, polyvinylbutyral, acrylic resins such as polymethylacrylate, polybutylacrylate, polymethylmethacrylate and polybutylmethacrylate and copolymers of these acrylates, phenol resins, styrene-butadiene resins, ethyl cellulose, epoxy resins and urethane resins or polymer latexes of these polymers may be used.

Among these compounds, gelatins and polyvinyl alcohol are preferred.

Various surfactants may be used in the light and heat sensitive recording layer constituting the light and heat sensitive recording material of the present invention for various purposes, specifically, these surfactants may serve as a coating adjuvant and antistatic agent, improve sliding characteristics and emulsion-dispersing characteristics and prevent adhesion.

Examples of materials which can be used as the surfactant include nonionic surfactants such as saponin, anionic surfactants such as polyethylene oxide, polyethylene oxide derivatives, e.g., alkyl ether of polyethylene oxide, alkyl sulfonate, alkylbenzene sulfonate, alkylnaphthalene sulfonate, alkyl sulfate, N-acyl-N-alkyltaurines, sulfosuccinates and sulfoalkylpolyoxyethylene alkylphenyl ethers, amphoteric surfactants such as alkylbetaines and alkylsulfobetaines and cationic surfactants such as aliphatic or aromatic quaternary ammonium salts.

In addition to the aforementioned additives, other additives may be compounded in the light and heat sensitive recording layer according to need.

For example, dyes, ultraviolet absorbers, plasticizers, fluorescent brighteners, matt agents, coating adjuvants, hardeners, antistatic agents and sliding characteristic improvers may be added.

Typical examples of the above additives are described in “Research Disclosure, Vol. 176” (December, 1978, Item 17643) and “Research Disclosure, Vol. 187” (November, 1979, Item 18716).

In the light and heat sensitive recording material used in the present invention, a hardener may be used together in each of the light and heat sensitive recording layer, the intermediate layer and the protective layer according to need.

Particularly, it is preferable to use the hardener together in the protective layer to decrease the adhesiveness of the protective layer. As the hardener, “gelatin hardeners” which are used in the production of a photographic light-sensitive material are useful. Examples of the gelatin hardener which may be used as the hardener of the present invention include aldehyde type compounds such as formaldehyde and glutaraldehyde, reactive halogen compounds as described in U.S. Pat. No. 3,635,718, compounds having a reactive ethylenic unsaturated group as described in U.S. Pat. No. 3,635,718, aziridine type compounds as described in U.S. Pat. No. 3,017,280, epoxy type compounds, halogenocarboxyaldehydes such as mucochloric acid and dioxanes such as dihydroxydioxane and dichlorodioxane as described in U.S. Pat. No. 3,091,537, vinylsulfones as described in U.S. Pat. Nos. 3,642,486 and 3,687,707, vinylsulfone precursors as described in U.S. Pat. No. 3,841,872 and ketovinyls as described in U.S. Pat. No. 3,640,720. Also, as an inorganic hardener, chrome alum, zirconium sulfate and boric acid may be used.

Among these hardeners, compounds such as 1,3,5-triacryloyl-hexahydro-s-triazine, 1,2-bisvinylsulfonylmethane, 1,3-bis(vinylsulfonylmethyl)propanol-2, bis(α-vinylsulfonylacetamide)ethane, 2,4-dichloro-6-hydroxy-s-triazine sodium salt, 2,4,6-triethylenimino-s-triazine and boric acid are preferable.

The hardener is preferably added in an amount ranging from 0.5 to 5 mass % based on the amount of the binder to be used.

<Production of the Light and Heat Sensitive Recording Material>

After a coating solution for the light and heat sensitive recording layer, a coating solution for the thermoadhesive layer and the like are prepared by a means for dissolving each of the aforementioned structural components in a solvent as required, each coating solution is applied one by one to a desired support and dried to obtain the light and heat sensitive recording material applied to the present invention.

Given as examples of a solvent which can be used for the preparation of the coating solution are single solvents of water; alcohols such as methanol, ethanol, n-propanol, isopropanol, n-butanol, sec-butanol, methyl cellosolve and 1-methoxy-2-propanol; halogen type solvents such as methylene chloride and ethylene chloride; ketones such as acetone, cyclohexanone and methyl ethyl ketone; esters such as methyl cellosolve acetate, ethyl acetate and methyl acetate; toluene and xylene; and mixtures of these solvents. Among these solvents, water is particularly preferable.

In order to apply the coating solution for the light and heat sensitive recording layer to the support, a blade coater, rod coater, knife coater, roll doctor coater, reverse roll coater, transfer roll coater, gravure coater, kiss roll coater, curtain coater or extrusion coater may be used.

As to a coating method, the coating solution may be applied with reference to “Research Disclosure, Vol. 200” (December, 1980, Item 20036 Clause XV).

The layer thickness of the light and heat sensitive recording layer is preferably in a range from 0.1 to 50 μm and more preferably in a range from 5 to 35 μm.

In the case of using the light and heat sensitive recording material of the present invention for the formation of a color image, a full-color image having an excellent color tone can be formed by providing only recording layers corresponding to each of three colors of cyan, magenta and yellow. The light and heat sensitive recording material of the present invention may be utilized in diversified applications.

For example, these applications include color printers, labels, color-proofs, copiers, facsimiles and second master drawings.

<Support>

Examples of the support used for the light and heat sensitive recording material according to the present invention include synthetic paper such as paper, coated paper and laminated paper, films such as polyethylene terephthalate films, cellulose triacetate films, polyethylene films, polystyrene films and polycarbonate films; plates of metals such as aluminum, zinc and copper; or those provided with various treatments, such as surface treatment, undercoating and metal deposition treatments, performed on the surface of these support materials. Further, the supports described in “Research Disclosure, Vol. 200” (December, 1980, Item 20036 Clause XVII) may be exemplified. Sheets of polyurethane foam or rubber in which the support itself is elastic may also be used.

Moreover, an antihalation layer may be disposed on the surface of the support and a slip layer, an antistatic layer, anti-curling layer, an adhesive layer and the like may be disposed on the backface of the support according to need.

Among the aforementioned support materials used as the support in the light and heat sensitive recording material according to the present invention, paper coated with an electron-ray radiation-curable resin and paper coated with a polyethylene resin are preferable and polyethylene resin coated paper produced by coating base paper with a polyethylene resin by melt extrusion molding are more preferable.

When the light and heat sensitive recording material is used in the transfer system, the light and heat sensitive recording layer is transferred to an image-receiving material through the thermoadhesive layer by contact-heating. For this, the support preferably has elasticity to improve adhesion to the image-receiving material. Such a support may be a sheet in which the support itself is formed of an elastic material and also those provided with an elastic layer formed of an elastic material on a general support (on the side formed with the light and heat sensitive recording layer) exemplified above.

Examples of the elastic material applicable to the support include elastomers such as natural rubber, acrylate rubber, butyl rubber, butadiene rubber, isoprene rubber, styrene-butadiene rubber, chloroprene rubber, urethane rubber, silicone rubber, acrylic rubber, fluoro-rubber, neoprene rubber, polyethylene chlorosulfonate, epichlorohydrin, EPDM and urethane elastomer and resins having small elasticity among polyethylene, polypropylene, polybutadiene, polybutene, polyurethane, ABS resins, acetate, cellulose acetate, amide resins, polystyrene, epoxy resins, phenolformaldehyde resins, polyester, acrylic resins, ethylene/vinyl acetate copolymers, acrylonitrile/butadiene copolymers, vinyl chloride/vinyl acetate copolymers, vinyl acetate resins, soft vinyl chloride resins, polyvinylidene chloride and polytetrafluoroethylene. The elastic layer and the elastic support are formed using each of these materials as its major component.

The image-receiving material usable when the method of the present invention is applied to a transfer system recording material is a material to be the support of the light and heat sensitive recording layer after transferred. As the image-receiving material, the materials which are exemplified as the support material of the light and heat sensitive recording material and which include usual paper support (ordinary paper) may be used.

Also the surface of each of these supports may be subjected to treatment such as glow discharge treatment or corona discharge treatment to improve adhesion to the thermoadhesive layer.

It is to be noted that the formation of the thermoadhesive layer which is formed as desired on the outermost layer of the light and heat sensitive recording material may be omitted by using an image-receiving material provided with the thermoadhesive layer formed in advance on the support.

(Image-Recording Method Using the Light and Heat Sensitive Recording Material)

In the light and heat sensitive recording material of the present invention, an image can be formed by carrying out thermal developing treatment at the same time of or after exposure to form a latent image.

As a heating method in the thermal developing treatment, a conventionally known method may be used. Generally, the heating temperature is preferably 80 to 200° C. and more preferably 85 to 130° C. The heating time is preferably in a range from 3 seconds to 1 minute and more preferably in a range from 5 seconds to 30 seconds.

It is desirable to fix the formed image and to remove, decompose or deactivate components, such as the spectral sensitizing compound and diazonium salt compound left in the recording layer, which decrease the whiteness of the background portion by irradiating the surface of the recording layer with light.

By this process, the components which are left unremoved in the recording layer including the background portion (non-image portion) and which color the background portion can be removed and the diazonium salt compound can be deactivated to thereby suppress a color-developing reaction. Therefore, a variation in the density in the image can be suppressed and image-preservation ability can be greatly improved.

In the case of the transfer system, thermal developing treatment of the light and heat sensitive material is hardened out in a manner that the thermoadhesive layer is in close contact with the image-receiving material after an exposure step of forming a latent image. An image is thus formed and bonding between the image-receiving material and the thermoadhesive layer at a pre-transfer stage is achieved.

As a heating and bonding method in the heat treatment, a conventionally known method using a means such as a heat roller and preferably a heat embossing roller may be used. Generally, the heating temperature is preferably 80 to 200° C. and more preferably 85 to 130° C. The heating time is preferably in a range from 3 seconds to 1 minute and more preferably in a range from 5 seconds to 30 seconds.

After the thermal developing treatment, the support is peeled off to accomplish the transfer whereby the light and heat sensitive recording layer in which the image is formed on the image-receiving material is transferred. By this transfer operation, the UV absorption layer and protective layer formed adjacent to the support are positioned at the outermost layer of the light and heat sensitive recording layer. These layers are positioned at the lowermost layer when an image is formed. Therefore these layers do not hinder the irradiation with light when the latent image is formed and are positioned at the uppermost layer after being transferred and can efficiently protect the formed image.

Also in the case of transfer system, the surface of the transferred light and heat sensitive recording layer is irradiated with light in the same manner as above whereby the formed image is fixed and the image preservation ability is greatly improved.

When an image is formed using the light and heat sensitive recording material of the present invention, a process of uniformly preheating the entire surface of the recording material at a prescribed temperature less than the temperature at which color is developed during the formation of an image is provided to further improve the sensitivity.

Also, not only the aforementioned recording method but also known other recording methods may be used for image recording on each recording layer of the light and heat sensitive recording material of the present invention.

For example, the light and heat sensitive recording material may be used also in the thermal recording method using heating equipment such as a thermal head and in a recording method which is proposed by 3 M for the purpose of improving qualities as described in PCT National Laid-open No. WO95/31754 and in which when a silver halide light and heat sensitive recording material is irradiated with a laser beam, the recording material is irradiated such that the beam spots are overlapped on each other in a specified range to thereby form an image. The density of the color image can be controlled by regulating the range in which the beam spots are overlapped on each other.

Also, the light and heat sensitive recording material of the present invention may be used in a recording method proposed by Canon as described in JP-A-60-195568. Specifically, the recording material may be used in technologies in which the angle of incidence of a laser beam applied to the surface of a recording material is inclined so that the reflection pitch of the incident beam reflected on the interface of a light-sensitive layer of the recording material is made larger than the diameter of the beam spot and by using techniques for preventing light interference generated in the recording material, a higher quality image is obtained. In this case, the density of the color image may be controlled by regulating the energy of the laser beam to be applied.

### EXAMPLES

The present invention will be explained in more detail by way of examples, which are not intended to be limiting of the present invention.

<Preparation of a thermally responsive microcapsule including an electron-donating colorless dye>

7.65 g of the following electron-donating colorless dye (1) developing a cyan color and 1.35 g of the following electron-donating colorless dye (2) were dissolved in 18.4 g of ethyl acetate. Then, 14.0 g of a capsule wall material (trademark: Takenate D-110N, manufactured by Takeda Chemical Industries) and 0.7 g of a capsule wall material (trademark: Milionate MR400, manufactured by Nippon Polyurethane Industry) were added to the ethyl acetate solution.

The resulting solution was added to a mixed solvent of 70 g of 5.9% gelatin phthalate and 0.34 g of a 10% sodium dodecylbenzene sulfonate solution. The mixture was then emulsion-dispersed at 30° C. to obtain an emulsion. To the resulting emulsion were added 64 g of water and 0.62 g of diethylenetriamine and the mixture was heated to 65° C. while being stirred. After 3 hours passed, water was added to adjust the solid content to 25 mass % and obtain a microcapsule solution having an average particle diameter of 0.5 μm.

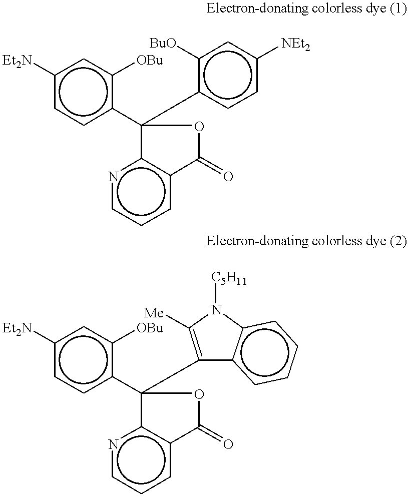

<Preparation of an Emulsion of a Photopolymerizable Composition>

4.6 g of the following organic borate compound (1), 0.8 g of the following spectral sensitizing dye compound (2), 0.3 g of the following compound (3), 0.8 g of the following compound (4) and 38 g of each of the following polymerizable electron-receiving compounds (5-a) and (5-b) were dissolved in 94 g of isopropyl acetate.

The resulting solution was added to a mixed solution consisting of 230 g of a 8% gelatin solution and 13 g of a sodium dodecylbenzene sulfonate solution and then the mixture was emulsion-dispersed at 30° C.

Following that, the resulting emulsion was stirred at 40° C. for 3 hours and a solvent was removed from the emulsion. Thereafter, water was added to adjust the solid content to 30 mass % to obtain an emulsion of a photopolymerizable composition having an average particle diameter of 0.3 μm.

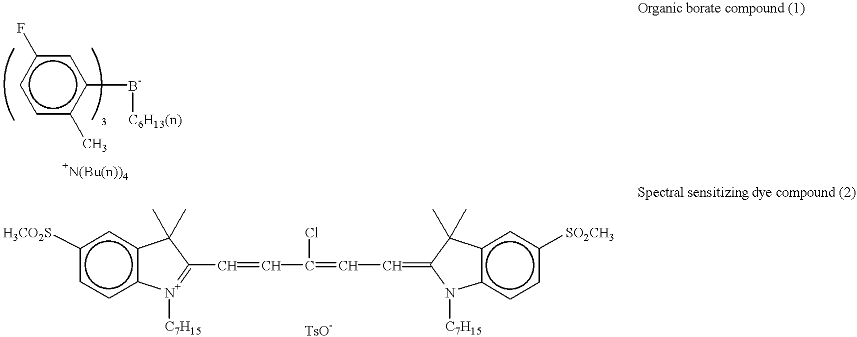

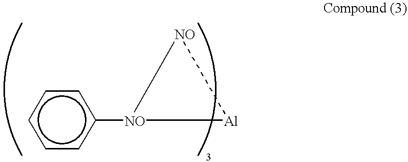

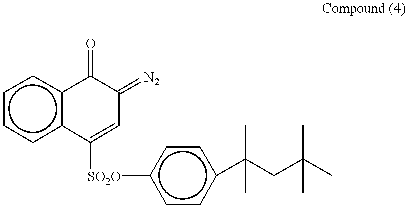

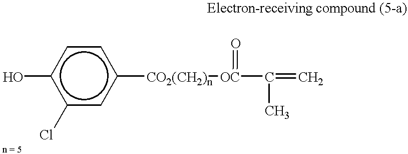

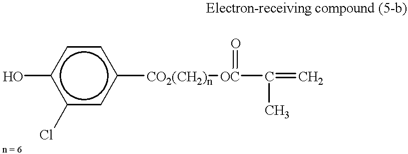

<Preparation of a coating solution for a light and heat sensitive recording layer>

8.4 g of the aforementioned emulsion of a photopolymerizable composition, 3.3 g of the aforementioned thermally responsive microcapsule solution including an electron-donating colorless dye and 0.9 g of a 15% gelatin solution were mixed to prepare a coating solution for a light and heat sensitive recording layer.

When a coating solution for a light and heat sensitive recording layer is applied to form a multilayer, the effect of improving the sensitivity to exposure is substantially obtained only the lowermost layer. Hence, the example describes the case of applying a coating solution to form a monolayer. However, there is no limitation to the number of layers and layer structures.

In Examples and Comparative Examples described below, supports A and B are used. The support A shows electron ray-curable resin-coated paper and the support B shows polyethylene resin-coated paper. Also, in the Examples and Comparative Examples described below, the value of dry weight (g/m²) of a non-color-developing layer after formation by application is equal to the value of the thickness (μm) of the non-color-developing layer.

### Comparative Example 1

As a non-color-developing layer, a mixture in which 0.3 g of an aqueous 2% 2-ethylhexyl sulfosuccinate solution was added as a coating adjuvant to 100 g of an aqueous 10% gelatin solution was prepared and applied to the support B such that the dry weight was 0.3 g/m². This was followed by drying to form a undercoat layer. The aforementioned coating solution for a light and heat sensitive recording layer was applied to the undercoat layer such that the dry weight was 3.5 g/m² and dried. Further, a protective layer was applied to the light and heat sensitive recording layer such that the dry weight was 1.5 g/m² and dried to obtain a light and heat sensitive recording material.

### Comparative Example 2

As a non-color-developing layer, a mixture in which 1.5 g of an aqueous 2% 2-ethylhexyl sulfosuccinate solution was added as a coating adjuvant to 100 g of an aqueous 10% gelatin solution was prepared and applied to the support A such that the dry weight was 2 g/m² and this was followed by drying to form a undercoat layer. The aforementioned coating solution for a light and heat sensitive recording layer was applied to the undercoat layer such that the dry weight was 3.5 g/m² and dried. Further, a protective layer was applied to the light and heat sensitive recording layer such that the dry weight was 1.5 g/m² and dried to obtain a light and heat sensitive recording material.

### Example 1

8 parts by mass of water-swellable synthetic mica (trademark: Somashif ME100, manufactured by Cope Chemical) was mixed with 92 parts by mass of water and the mixture was wet-dispersed using a viscomill to prepare a mica dispersion having an average particle diameter of 2.0 μm. 950 parts by mass of water was added to 100 parts by mass of the dispersion and the both were uniformly mixed. Thereafter, 500 parts by mass of an aqueous 15% alkali-treated gelatin solution was added to the mixture while the mixture was kept at 40° C. and stirred. Further, 50 parts by mass of 2% sodium (4-nonylphenoxytrioxyethylene)butyl sulfonate was added to the resulting mixture to obtain an undercoating solution containing mica. The resulting undercoating solution was applied to the support A such that the dry weight was 2.0 g/m² and dried to form an undercoat layer.

The aforementioned coating solution for a light and heat sensitive recording layer was applied to the undercoat layer such that the dry weight was 3.5 g/m² and dried. Further, a protective layer was applied to the light and heat sensitive recording layer such that the dry weight was 1.5 g/m² and dried to obtain a light and heat sensitive recording material.

### Example 2

8 parts by mass of water-swellable synthetic mica (trademark: Somashif ME100, manufactured by Cope Chemical) was mixed with 92 parts by mass of water and the mixture was wet-dispersed using a viscomill to prepare a mica dispersion having an average particle diameter of 2.0 μm. 1500 parts by mass of an aqueous 5% polyvinyl alcohol (PVA124C, manufactured by Kuraray) solution was added to 100 parts by mass of the dispersion. Further, 50 parts by mass of 2% sodium (4-nonylphenoxytrioxyethylene)butyl sulfonate was added to the resulting mixture to obtain an undercoating solution containing mica. The resulting undercoating solution was applied to the support B such that the dry weight was 2.0 g/m² and dried to form an undercoat layer.

The aforementioned coating solution for a light and heat sensitive recording layer was applied to the undercoat layer such that the dry weight was 3.5 g/m² and dried. Further, a protective layer was applied to the light and heat sensitive recording layer such that the dry weight was 1.5 g/m² and dried to obtain a light and heat sensitive recording material.

### Example 3

A light and heat sensitive recording material was obtained in the same manner as in Example 1 except that the support was changed to the support B.

<Measurement and Evaluation of Recording Sensitivity at a Time of Exposure and of Thermal Fogging>

The light and heat sensitive recording materials obtained in Comparative Examples 1 and 2 and Examples 1 to 3 were measured and evaluated for recording sensitivity at a time of exposure and thermal fogging.

The measurement of recording sensitivity at a time of exposure was made in the following manner: each resulting light and heat sensitive recording material was exposed to semiconductor laser light having a wavelength of 657 nm and then heated at 110° C. for 10 seconds to form step wedge patterns from Dmin to Dmax. From this sample, a light energy required to obtain an optical density (OD) of ½ the Dmax was calculated and defined as the recording sensitivity at a time of exposure. The lower the value of the recording sensitivity is, the higher the sensitivity is evaluated to be.

On the other hand, the thermal fogging was measured as follows: a untreated sample was inserted into a moistureproof and light-shielding bag and heat-sealed. The sample was then subjected to 3d thermal treating performed at 50° C. to find a difference (ΔDmin) between the optical densities (OD) of the background portion (Dmin) before and after the thermal treatment was hardened out. The value of ΔDmin was defined as the thermal fogging. In the case where the value of ΔDmin was less than 0.05 was made “O” and in the case where the value of ΔDmin was 0.05 or more was made “X”.

The results of the measurement of the light and heat sensitive recording materials obtained in the above comparative examples and examples are shown in Table 1.

TABLE 1

| | | | Recording | |
|---|---|---|---|---|
| | Undercoat layer | Coating | sensitivity | |
| | (non-color | amount | to exposure | Thermal |
| | developing layer) | (g/m²) | (D50) mJ/cm² | fogging |
| Comparative | Gelatin | 0.3 | 3.5 | X |
| Example 1 | | | | |
| Comparative | Gelatin | 2 | 2 | ◯ |
| Example 1 | | | | |
| Example 1 | Gelatin + Mica | 2 | 0.4 | ◯ |
| Example 2 | PVA124C + | 2 | 0.4 | ◯ |
| | Mica | | | |
| Example 3 | Gelatin + Mica | 2 | 0.6 | ◯ |

◯: ΔDmin is less than 0.05.
X: ΔDmin is 0.05 or more.

It was confirmed that in the examples of the present invention, the non-color-developing layer containing synthetic mica which was a swellable inorganic layer compound was formed by application as an undercoat layer of the light and heat sensitive recording layer, whereby all examples were more improved in recording sensitivity at a time of exposure compared with the comparative examples using the non-color-developing layer containing no synthetic mica as the undercoat layer.

It was also confirmed that a high quality image which is free from thermal fogging was obtained at high speed in the examples.

The present invention can provide a light and heat sensitive recording material which has high recording sensitivity at a time of exposure and can form a high quality image at high speed.

What is claimed is:

1. A light and heat sensitive material comprising, on a support, a light and heat sensitive recording layer comprising a color-developing component A encapsulated in a thermally responsive microcapsule and a photopolymerizable composition including a substantially colorless compound B having at least a polymerizable group and a portion which reacts with the color-developing component A to develop a color in the same molecule and a photoinitiator outside of the thermally responsive microcapsule, and at least one non-color-developing layer containing a swellable inorganic layer compound.

2. A light and heat sensitive recording material according to claim 1, wherein the at least one of said non-color-developing layers is disposed as an undercoat layer between said support and said light and heat sensitive recording layer.

3. A light and heat sensitive recording material according to claim 1, wherein the at least one of said non-color-developing layers is formed as an intermediate layer between said light and heat sensitive recording layers.

4. A light and heat sensitive recording material according to claim 1, wherein the at least one of said non-color-developing layers is formed as a back coat layer on the side of said support opposite to said light and heat sensitive recording layer.

5. A light and heat sensitive recording material according to claim 1, wherein the thickness of said non-color-developing layer is 0.5 μm to 5.0 μm.

6. A light and heat sensitive recording material according to claim 1, wherein the thickness of said non-color-developing layer is 0.5 μm to 2.0 μm.

7. A light and heat sensitive recording material according to claim 1, wherein said non-color-developing layer includes a binder component and includes at least one type among a gelatin, a gelatin derivative, a graft copolymer of a gelatin and other polymer, a polyvinyl alcohol type polymer, a polyamide type polymer and a polymer having an amide group and a carboxyl group as the binder component.

8. A light and heat sensitive recording material according to claim 7, wherein the ratio (swellable inorganic layer compound:binder) by mass of said swellable inorganic layer compound to said binder component in said non-color-developing layer is 1:100 to 55:100.

9. A light and heat sensitive recording material according to claim 7, wherein said gelatin derivative is a gelatin derivative obtained by reacting a compound selected from acid halides, acid anhydrides, isocyanates, bromoacetic acid, alkane sultones, vinylsulfonamides, maleinimide compounds, polyalkylene oxides and epoxy compounds with a gelatin.

10. A light and heat sensitive recording material according to claim 1, wherein said non-color-developing layer includes a binder component and includes at least one type among a gelatin, a polyvinyl alcohol and a modified polyvinyl alcohol as the binder component.

11. A light and heat sensitive recording material according to claim 10, wherein said gelatin is selected from a gelatin treated with lime, a gelatin treated with an acid, a hydrolyzed gelatin and an enzymatically decomposed gelatin.

12. A light and heat sensitive recording material according to claim 10, wherein said modified polyvinyl alcohol is selected from a carboxy modified polyvinyl alcohol, a silanol modified polyvinyl alcohol and an epoxy modified polyvinyl alcohol.

13. A light and heat sensitive recording material according to claim 1, wherein the aspect ratio of said swellable inorganic layer compound is 20 or more.

14. A light and heat sensitive recording material according to claim 1, wherein the aspect ratio of said swellable inorganic layer compound is 500 or more.

15. A light and heat sensitive recording material according to claim 1, wherein said swellable inorganic layer compound is a mica particle.

16. A light and heat sensitive recording material according to claim 1, wherein said swellable inorganic layer compound is selected from bentonite, hectorite, saponite, teniorite, tetrasick mica, beidelite, nontronite, stevensite, montmorillonite, talc, zirconium phosphate, swellable clay minerals, swellable synthetic mica and swellable synthetic smectites.

17. A light and heat sensitive recording material according to claim 1, wherein said swellable inorganic layer compound is bentonite or swellable synthetic mica.

18. A light and heat sensitive recording material according to claim 16, wherein said swellable synthetic mica is a fluorine type swellable synthetic mica.

19. A light and heat sensitive recording material according to claim 18, wherein said fluorine type swellable synthetic mica is selected from NaMg_{2.5}(Si₄O₁₀)F₂, (NaLi)Mg₂Li(Si₄O₁₀)F₂ and (NaLi)_{1/3}Mg_{2/3}Li_{1/3}(Si₄O₁₀)F₂.
